(19) United States
(12) Patent Application Publication
(10) Pub. No.: US 2014/0011104 A1
(43) Pub. Date: Jan. 9, 2014

(54) Integrated Dry Gasification Fuel Cell System for Conversion of Solid Carbonaceous Fuels

(71) Applicant: The Board of Trustees of the Leland Stanford Junior University, Palo Alto, CA (US)

(72) Inventors: Turgut M. Gür, Palo Alto, CA (US); Reginald E. Mitchell, Oakland, CA (US)

(21) Appl. No.: 14/021,401

(22) Filed: Sep. 9, 2013

Related U.S. Application Data
(63) Continuation-in-part of application No. 12/215,681, filed on Jun. 26, 2008, now Pat. No. 8,563,183.
(60) Provisional application No. 60/937,459, filed on Jun. 26, 2007.

(51) Int. Cl. H01M 8/06

(52) U.S. Cl. CPC H01M 8/0675; H01M 8/0631
USPC 429/410

(57) ABSTRACT

A fluidized bed integrated dry gas fuel cell (FB-IDG-FC) is provided. The FB-IDG-FC includes a solid oxide fuel cell having an anode, a cathode and an electrolyte membrane disposed there between. The FB-IDG-FC further includes a conversion bed, where carbon dioxide gas is provided therein to convert carbon monoxide gas from the carbon dioxide gas. Solid carbonaceous fuel is provided to the conversion bed to promote the gas conversion. Carbon monoxide is provided as fuel to the anode, and air is supplied to the cathode to provide oxygen for oxidation of the carbon monoxide at the anode to generate electric power. No water is required, and oxygen is supplied for oxidation through an ionically selective solid oxide electrolyte membrane. This invention provides in situ capture and removal of sulfur, sulfurous compounds and other contaminants by solid sorbent from the carbon monoxide gas converted from carbon dioxide gas in the gasifier.

### CROSS-REFERENCE TO RELATED APPLICATIONS

This application is a continuation-in-part of U.S. patent application Ser. No. 12/215,681 filed Jun. 26, 2008, which is incorporated herein by reference. Application Ser. No. 12/215,681 filed Jun. 26, 2008 claims the benefit from U.S. Provisional Patent Application 60/937,459 filed Jun. 26, 2007, which is hereby incorporated by reference.

### FIELD OF THE INVENTION

The invention generally relates to fuel cells. In particular, the invention relates to fuel cells for solid carbonaceous fuel conversion.

### BACKGROUND OF THE INVENTION

Coal remains to be the cheapest and most abundant fossil fuel on earth, and is the primary energy source used for electric power generation. The United States possesses the largest proven coal reserves in the world, followed closely by vast reserves in Russia, China and India. So it is no coincidence that coal provides about 50% of the electricity generated in the US, and more than 75% in China and India. The World Coal Institute has estimated that at the current consumption levels, proven global coal reserves are sufficient to last for more than 150 years. Consequently, coal will remain a major energy resource well into the future.

However, coal-to-electricity conversion efficiency is in the low 30% regime for most pulverized coal-fired power plants currently in operation and in the mid 30% range for supercritical and ultrasupercritical power plants. They all produce copious quantities of carbon dioxide, a green house gas. Since air is used in these processes, the flue stream contains only about 10-15% CO₂ diluted with nitrogen. In the United States, 40% of the CO₂ emitted into the atmosphere comes from coal-fire power plants. In order to use coal in an environmentally benign manner, the CO₂ must be captured and sequestered. The most efficient process to achieve this goal is by electrochemical conversion using direct carbon fuel cells (DCFC). However, the contaminants in coal, in particular sulfur, pose a major bottleneck in advancing fuel cell technology for efficient coal conversion. Sulfur, a known poison for catalysts even in small quantities, rapidly deactivates the catalytic anode material and degrades the performance of fuel cells.

Although long in history going back 150 years, solid fuel conversion in high temperature fuel cells is gaining renewed interest as concerns about efficient and sustainable energy technologies, clean environment, and climate change grow in importance on the global agenda.

Most of these electrochemical studies employed carbon in molten carbonate fuel cell arrangements, and reported peak power densities of less than 100 mW/cm² at temperatures above 800° C. In these cells carbon either dispersed in the electrolyte or in the molten tin anode, or as sacrificial anode in bulk form is employed and is electrochemically oxidized. Conversion in these corrosive molten electrolytes, however, pose serious challenges due to slow kinetics in molten media, materials stability issues, wetting of the solid fuel by molten medium, and assuring electrical connectivity among carbon particles.

Solid oxide fuel cell (SOFC)-based arrangements circumvent many of these problems. However, it also introduces new challenges due to dimensional difficulty in supplying the solid fuel particles to the electrochemical reaction sites, called triple phase boundaries (TPB) located at the solid electrolyte/anode interface. This difficulty is largely overcome by gasification of the solid fuel whereby the syngas is electrochemically oxidized at the TPB.

What is needed is a device that is capable of in situ capture and removal of sulfur and sulfurous compounds from the carbon monoxide gas converted from carbon dioxide gas in the gasifier.

### SUMMARY OF THE INVENTION

To address the needs in the art, an integrated gas fuel cell that includes at least one carbon monoxide gas fueled solid oxide fuel cell, where the carbon monoxide gas fueled fuel cell includes a carbon monoxide oxidizing anode, where an anodic oxidation of the carbon monoxide is provided by the carbon monoxide oxidizing anode in the presence of carbon monoxide, a cathode, an oxide ion transporting electrolyte membrane, and a product stream output from the carbon monoxide oxidizing anode, where the membrane is disposed between the carbon monoxide oxidizing anode and the cathode. The invention further includes a gasifier, where the carbon monoxide gas fueled solid oxide fuel cell is integrated to the gasifier, where the gasifier converts carbon monoxide gas from carbon dioxide gas, where a bed of carbonaceous fuel is provided to the gasifier to facilitate the gas conversion, where the carbon monoxide gas is directly provided as fuel to the carbon monoxide oxidizing anode inside the gasifier, where the at least one carbon monoxide gas fuel cell is physically and thermally integrated with the gasifier within a single chamber, where a Boudouard reaction product carbon dioxide is formed directly inside the at least one carbon monoxide gas fueled solid oxide fuel cell, where when an electrochemical oxidation reaction of the carbon monoxide occurs at a surface of the carbon monoxide oxidizing anode by oxide ions supplied through the oxide ion transporting electrolyte membrane from the cathode for the electrochemical oxidation reaction of the carbon monoxide gas at the surface of the carbon monoxide oxidizing anode to generate electric power, where the electrochemical oxidation reaction includes CO(g)+O_{O}^{X}→CO₂(g)+V_{O}^{\ddot{}}+2e⁻ yielding electrons for the electrical power generation; and a solid sorbent bed inside the gasifier, where the solid sorbent bed is disposed for in situ capture and removal of sulfur and sulfurous compounds and other contaminants from the carbon monoxide gas converted from carbon dioxide gas in the gasifier, where the fuel cell, the gasifier, and the solid sorbent bed are within the same thermal and physical enclosure.

According to one aspect of the invention, the in situ capture and removal by the solid sorbent is further capable of removal of contaminants including phosphorus, mercury, arsenic, cadmium, antimony, selenium, lead, chromium, chlorine, fluorine, silicon and silicon compounds, alkaline earth metals, or, rare earth metals.

In a further aspect of the invention, the solid sorbent materials can include limestone, calcite, caco₃, magnesium carbonate, magnesium carbide, barium carbonate, barium carbide, strontium carbide, strontium carbonate, zinc carbonate, zinc carbide, dolomite (CaMg(CO₃)₂), meionite (Ca₃(Al₂Si₂O₈)₃CaCO₃) and vesuvianite, (Ca₁₉Mg₂Al₁₁Si₁₈O₆₉(OH)₉), K₂CO₃, CoCO₃, carbonates and carbides of Fe, Mg, Mn, carbonates and carbides of alkaline earth metals, carbonates and carbides of transition metals, NaCl, CaCl₂, Na₂Co₃, and Fe₂O₃, BaCO₃, SrC₂SrCO₃, ZnCO₃, K₂CO₃, MgCO₃, MgC₂, BaC₂, ZnC₂).

### BRIEF DESCRIPTION OF THE DRAWINGS

FIG. 1 shows a temperature dependence of Gibbs free energy and enthalpy for the Boudouard and CO oxidation reactions according to the present invention.

FIG. 2 shows a schematic of IDG-FC where the dry gasifier is integrated with an internal SOFC and external SOFC for electrical power extraction, with CO₂ and waste heat from a nearby coal-fired power plant according to the present invention.

FIG. 3 shows a schematic of IDG-FC where the dry gasifier is integrated with an internal SOFC and external SOFC for electrical power extraction, in a stand-alone configuration according to the present invention.

FIG. 4 shows a schematic of IDG-FC where the dry gasification process is integrated to an external SOFC for electrical power extraction, in a stand-alone configuration according to the present invention.

FIG. 5 shows a schematic of IDG-FC unit with a Rankine bottoming cycle for increased power output and efficiency according to the present invention.

FIG. 6 shows a FB-IDG-FC process design including a one-end closed tubular SOFC geometry at the center of the chamber with radially placed solid fuel and sorbent beds, and one example of gas and material flow patterns in the chamber, according to one embodiment of the invention.

FIG. 7 shows a FB-IDG-FC process design including a one-end closed tubular SOFC geometry at the center of the chamber with radially placed solid fuel and sorbent beds, and a second example of gas and material flow patterns in the chamber, according to one embodiment of the invention.

FIG. 8 shows a FB-IDG-FC process design including a open-ended tubular SOFC geometry at the center of the chamber with radially placed solid fuel and sorbent beds, and an example of gas and material flow patterns in the chamber, according to one embodiment of the invention.

FIG. 9 shows a FB-IDG-FC process design including a one-end closed tubular SOFC geometry radially circling the solid fuel and sorbent beds located at the center of the chamber, and one example of gas and material flow patterns in the chamber, according to one embodiment of the invention.

FIG. 10 shows a FB-IDG-FC process design including an open-ended tubular SOFC geometry at the center of the chamber with radially placed solid fuel and sorbent beds, and one example of gas and material flow patterns in the chamber, according to one embodiment of the invention.

FIG. 11 shows a FB-IDG-FC process design including an open-ended tubular SOFC geometry at the center of the chamber with radially placed solid fuel bed and the outermost sorbent bed, and one example of gas and material flow patterns in the chamber.

FIG. 12 shows a FB-IDG-FC process design including an open-ended tubular SOFC geometry at the center of the chamber with radially placed solid fuel bed and the outermost sorbent bed, and one example of gas and material flow patterns in the chamber, according to one embodiment of the invention.

FIG. 13 shows another FB-IDG-FC process design including an open-ended tubular SOFC geometry at the center of the chamber with radially placed solid fuel bed and the outermost sorbent bed, and one example of gas and material flow patterns in the chamber, according to one embodiment of the invention.

FIG. 14 shows a schematic drawing of FB-IDG-FC operating principle, according to one embodiment of the invention.

FIGS. 15a-15b show equilibrium concentrations of H₂S and COS in syngas after addition of selected sorbents, according to one embodiment of the invention.

### DETAILED DESCRIPTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

An integrated dry gasification fuel cell (IDG-FC) is provided that does not require the use of steam for the gasification process, while improving system conversion efficiency. The IDG-FC does not require the external use of pure oxygen gas flow into the gasifier along with steam. By using the selective oxygen transport property of solid oxide electrolytes, the IDG-FC eliminates the need for the expensive, energy intensive process of separating oxygen from air prior to the gasification step. The IDG-FC eliminates the need for water resources and the associated costs and environmental impacts, and provides a desirable alternative where water is scarce or too uneconomical to employ.

The present invention has the advantage of utilizing all forms of carbon containing solid fuels in the IDG-FC process. In the context of this invention, a solid carbonaceous fuel is defined as a solid fuel whose carbon content is more than 20% by weight on dry-basis, and preferably more than 40% by weight on dry-basis, where “dry” is upon the removal of water or moisture. Examples of solid carbonaceous fuels include, but not limited to, anthracite, biomass, coal, char, charcoal, forest residues, industrial carbon-containing wastes, lignite, manure, municipal solid wastes, paper pulp, peat, petroleum coke, refuse-derived wastes, saw dust, sewage sludge, solid wastes, or waste plastics. Similarly, examples of biomass include, but nor limited to wood, switchgrass, corn stover, rice straw, olive pits, grass, agricultural residues, and shells of almonds, walnuts, coconuts and other types of nuts.

Another important aspect of the IDG-FC process is the integration of a solid oxide fuel cell (SOFC) in order to improve the overall system conversion efficiency. The solid oxide electrolyte employed in the fuel cell is a selective membrane that only transports oxide ions and supplies the oxygen for the anodic oxidation of CO generated during the dry gasification step. The membrane can be electrolyte material that can include zirconia-based electrolytes, zirconia-based electrolytes doped with alkali or rare earth oxides, zirconia-based electrolytes in a cubic fluorite phase, ceria-based electrolytes, ceria-based electrolytes doped rare earth oxides, ceri-base electrolytes in a cubic fluorite phase, lanthanum gallate-based electrolytes, lanthanum gallate-based electrolytes doped with oxides of aliovalent metals, lanthanum gallate-based oxides of perovskite phase, zirconia-based electrolytes in a pyrocholore phase, lanthanum silicate-based electrolytes, lanthanum silicate-based electrolytes doped with oxides of aliovalent metals, or lanthanum silicate-based electrolytes in an apatite phase.

Predominantly oxide-ion conducting solids have been known to exist for almost a century. Among these solids, zirconia-based electrolytes have widely been employed as electrolyte material for solid oxide fuel cells. Zirconium dioxide has three well-defined polymorphs, with monoclinic, tetragonal and cubic structures. The monoclinic phase is stable up to about 1100° C. and then transforms to the tetragonal phase. The cubic phase is stable above 2200° C. with a CaF₂ structure. The tetragonal-to-monoclinic phase transition is accompanied by a large molar volume (about 4%), which makes the practical use of pure zirconia impossible for high temperature refractory applications. However, addition of 8-15 mole % of alkali or rare earth oxides (e.g., CaO, Y₂O₃, Sc₂O₃) stabilizes the high temperature cubic fluorite phase to room temperature and eliminates the undesirable tetragonal to monoclinic phase transition at around 1100° C. The dopant cations substitute for the zirconium sites in the structure.

When divalent or trivalent dopants replace the tetravalent zirconium, a large concentration of oxygen vacancies is generated to preserve the charge neutrality of the crystal. It is these oxygen vacancies that are responsible for the high ionic conductivity exhibited by these solid solutions. These materials also exhibit high activation energy for conduction that necessitates elevated temperatures in order to provide sufficient ionic transport rates. The electronic contribution to the total conductivity is several orders of magnitude lower than the ionic component at these temperatures. Hence, these materials can be employed as solid electrolytes in high temperature electrochemical cells.

The chemical potential difference of oxygen across the solid oxide electrolyte is a measure of the open circuit potential given by the Nernst Equation,

E=−(RT/nF)ln(P_{O}_{₂}_{,anode}/P_{O}_{₂}_{,cathode}) (1)

where E is the equilibrium potential of the fuel cell under open circuit conditions, R is the gas constant, F is Faraday's constant, n is the number of electrons per mole (in the case of O₂, n=4), and P_{O}_{₂} denotes the partial pressure of oxygen. At the anode, the equilibrium oxygen partial pressure is governed by the CO/CO₂ ratio at the operating temperature and total pressure, while at the cathode it is fixed by the oxygen activity in air.

The Boudouard reaction, written in global form in (2), is employed in the IDG-FC process in order to generate carbon monoxide from the carbon dioxide that enters the gasifier.

CO₂(g)+C(s)→2CO(g) (2)

This global chemical reaction is kinetically slow compared to carbon (or coal) combustion. However, the presence of large amounts of solid carbon relative to gas allows for a small conversion of the solid carbonaceous fuel to produce large changes in gas concentration. There are several benefits of using the Boudouard reaction products directly in the SOFC. First, no separate gasifier is needed thus reducing geometric space requirements. Secondly, the activity of carbon is fixed at one, and within the bed there is a constant conversion of CO₂ to CO. This works to increase the CO activity in the flow direction, thus maintaining the CO concentration and providing more power density.

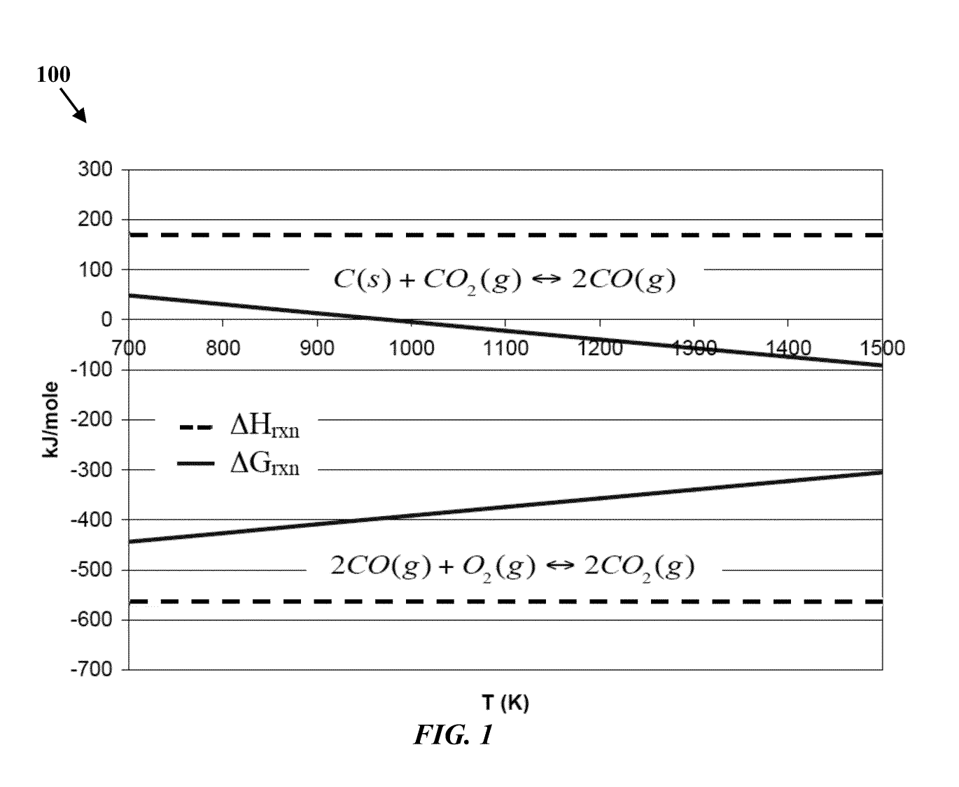

Referring now to the figures, FIG. 1 shows a temperature dependence chart 100 of Gibbs free energy and enthalpy for the Boudouard and CO oxidation reactions. FIG. 1 shows the heat of reaction and free energy for the Boudouard reaction at temperatures of interest, and compares these values with the enthalpy and free energy for CO oxidation. The energy required to drive the endothermic Boudouard reaction (ΔH_{r×n}), shown in dashed lines, is nearly constant at about 170 kJ per mole of carbon gasified. The free energy of reaction (ΔG_{r×n}), shown in solid lines, indicates that CO formation is favored above about 1000° K, and becomes more favorable with higher temperatures. At a gasifier design temperature of 900° C. (1173° K), the equilibrium CO-to-CO₂ molar ratio is about 32-to-1 for this reaction when there is an excess of carbon maintained in the gasifier. This CO/CO₂ mixture is slightly diluted with gases released from the coal during devolatilization (H₂O, H₂, H₂S, COS, HCl, Cl₂, SO₂, NH₃, N₂ and low molecular weight hydrocarbons), but generally not to a large extent.

As noted in FIG. 1, the highly exothermic heat of reaction for the CO oxidation reaction (−560 kJ/mole) is more than sufficient to meet the endothermic heat requirement for the Boudouard reaction. The carbon monoxide produced via the gasification reactions is employed as fuel in a solid oxide fuel cell to generate electric power. Air is supplied to the cathode of the fuel cell, providing oxygen for CO oxidation at the anode. The overall course of the electrochemical oxygen reduction reaction at the cathode is given by:

O₂(g)+2V_{O}^{\ddot{}}+4e→2O_{O}^{X} (3)

Oxygen ions, O_{O}^{X}, are transported across the solid electrolyte of the fuel cell from the cathode to the anode and oxygen vacancies, V_{O}^{\ddot{}}, migrate under the influence of the chemical potential gradient from the anode to the cathode. The oxygen ions are consumed at the anode via reactions with the CO produced in the coal bed. The overall course of the electrochemical reactions that take place at the anodic surface are described by (4).

CO(g)+O_{O}^{X}→CO₂(g)+V_{O}^{\ddot{}}+2e⁻ (4)

The overall reaction sequence for carbon conversion in the IDG-FC is the sum of reactions (2) and (4), and can be represented as

C(s)+2O_{O}^{X}→CO₂(g)+2V_{O}^{\ddot{}}+4e⁻ (5)

while the oxygen supplied for this conversion is given by reaction (3). So for every carbon atom freshly supplied by coal is reacted, four electrons travel through the external circuit of the fuel cell generating electricity.

Any hydrogen produced in the coal bed will be oxidized electrochemically to water at the anodic surface via reaction (6) generating additional electricity.

H₂(g)+O_{X}^{O}→H₂O(g)+V_{O}^{\ddot{}}+2e⁻ (6)

All volatile matter released during heating of the coal will be oxidized at the anode as well.

In the present invention, before the CO₂-rich stream is directed to a sequestration site, it is employed in a dry gasification process to generate CO, which is then used in an arrangement of solid oxide fuel cells (SOFCs) to generate electricity. In all the examples and figures presented below, coal is intended as representative of all types of solid carbonaceous fuels, including but not limited to anthracite, biomass, coal, char, charcoal, forest residues, industrial carbon-containing wastes, lignite, manure, municipal solid wastes, paper pulp, peat, petroleum coke, refuse-derived wastes, saw dust, sewage sludge, solid wastes, or waste plastics. Similarly, examples of biomass include, but nor limited to wood, switchgrass, corn stover, rice straw, olive pits, grass, agricultural residues, and shells of almonds, walnuts, coconuts and other types of nuts.

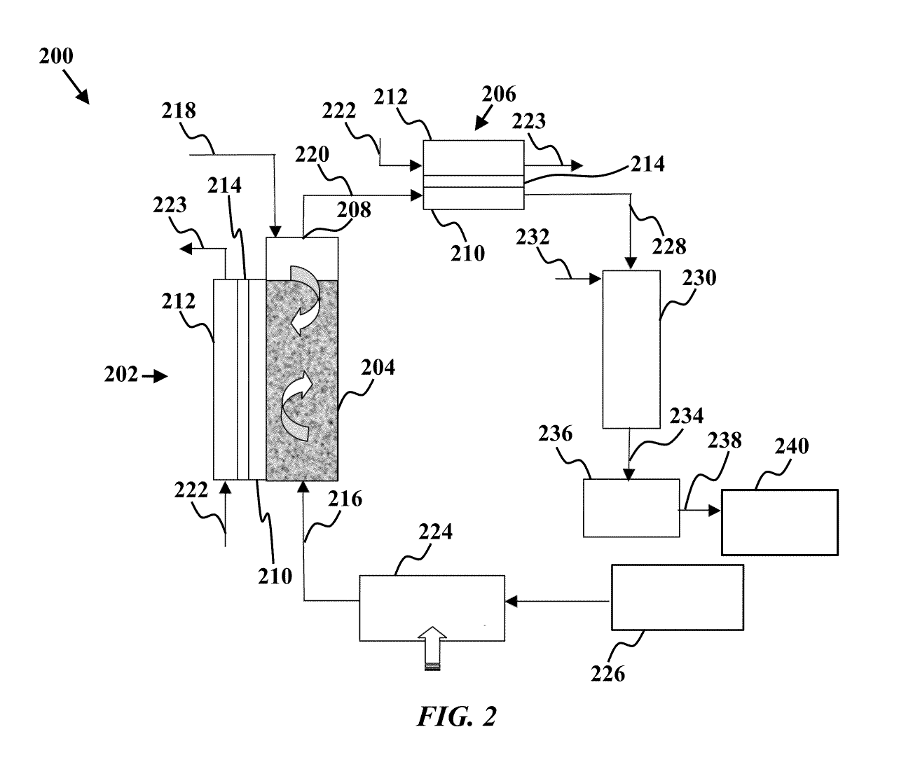

According to one embodiment of the current invention, FIG. 2 shows a SOFC bundle configuration 200, where one internal SOFC 202 is used directly inside the gasifier (conversion bed) 204, and another external fuel cell bundle 206 is located at the gasifier exit 208. As shown, the fuel cell 202 includes an anode 210, a cathode 212 and an electrolyte membrane 214, where the membrane 214 is disposed between the anode 210 and the cathode 212. Carbon dioxide gas is provided to the conversion bed 206 through a carbon dioxide gas input 216 and the conversion bed 206 converts carbon monoxide gas from the carbon dioxide gas. Solid carbonaceous fuel is provided to the conversion bed 206 through a carbonaceous fuel input 218 to promote the gas conversion. The carbon monoxide is provided as fuel to the anode 210 through a fuel input 220, and air is supplied to the cathode 212 through an air input 222 and an air output 223 to provide oxygen and exhaust air for oxidation of the carbon monoxide at the anode 212 to generate electric power.

Further shown in FIG. 2 is an example of when the process of the current invention is located at a coal-fired power plant (not shown), and in many cases, an air separation unit (not shown) is available to permit combustion in oxygen. Here, integration with the power plant's waste heat streams in a waste heat recovery element 224 enables a heating the CO₂ before it enters the gasifier 204 through the carbon dioxide gas input 216, where the CO₂ may be provided from a gas separation unit 226. Also shown, the fuel cell 202/206 includes a product stream output 228 from the anode 210 that is input to a CO burner 230 having an O₂ input 232. The combustor 230 is used to oxidize any CO in the SOFC product stream 228. A CO burner exhaust stream 234 is input to a gas cleanup element 236 having an gas cleanup output CO₂ stream 238 for input to a sequestration site 240.

Although the gasification reactions are kinetically controlled and hence, relatively slow with respect to consumption of the solid carbon or char particles, a large amount of gas is generated when the gasifier is filled with an ample amount of coal. According to another embodiment, the CO₂ gas is restricted from entering said conversion bed 204. The power generated in the fuel cells 202/206 increases both the power output and efficiency of the power plant, and has the potential to offset the cost of the carbon capture and sequestration (CCS) system.

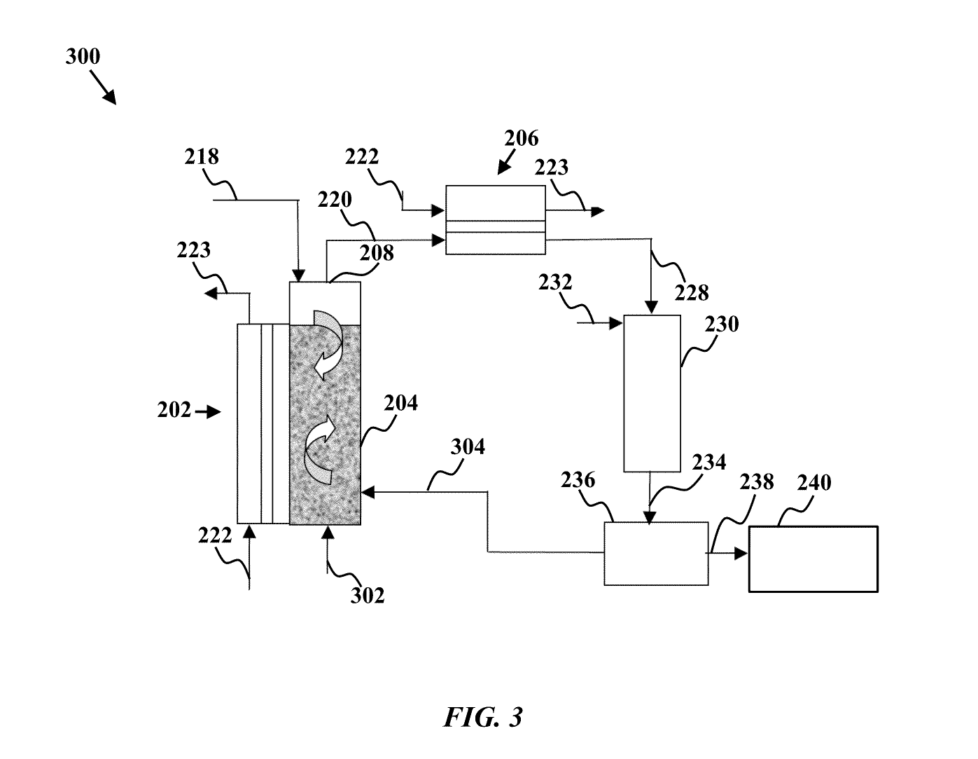

FIG. 3 shows the IDG-FC process employed as a “standalone” electric power generation system 300. In this configuration, any additional process heat to IDG-FC that cannot be provided by the large difference in the enthalpies (see FIG. 1) of reactions (2) and (4) may be supplemented by supplying a sub-stoichiometric amount of oxygen through an O₂ input 302 to the gasifier 204 along with the CO₂ and carbonaceous fuel. The oxygen reacts with the coal releasing energy as heat, which adds to the strongly exothermic enthalpy of reaction (4) to drive the endothermic char-CO₂ gasification reactions. For example fresh coal enters the top of the gasifier 204 through the coal feed 218, and oxygen and preheated CO₂ enter the bottom. In this counter-flow arrangement, the sensible energy of the CO and CO₂ generated during exothermic char oxidation in the bottom regions of the gasifier 204 is used to drive the coal gasification reactions in the middle to upper regions of the gasifier 204. FIG. 3 shows additional energy to drive the endothermic gasification reactions is provided by the exhaust stream 234 of the combustor 230 used to oxidize any CO in the SOFC product stream 228. A portion of the hot CO₂ leaving the combustor 230 is recycled CO₂ 304 that is directed back to the gasifier 204 and a portion is directed to the intended CO₂ sequestration site 240.

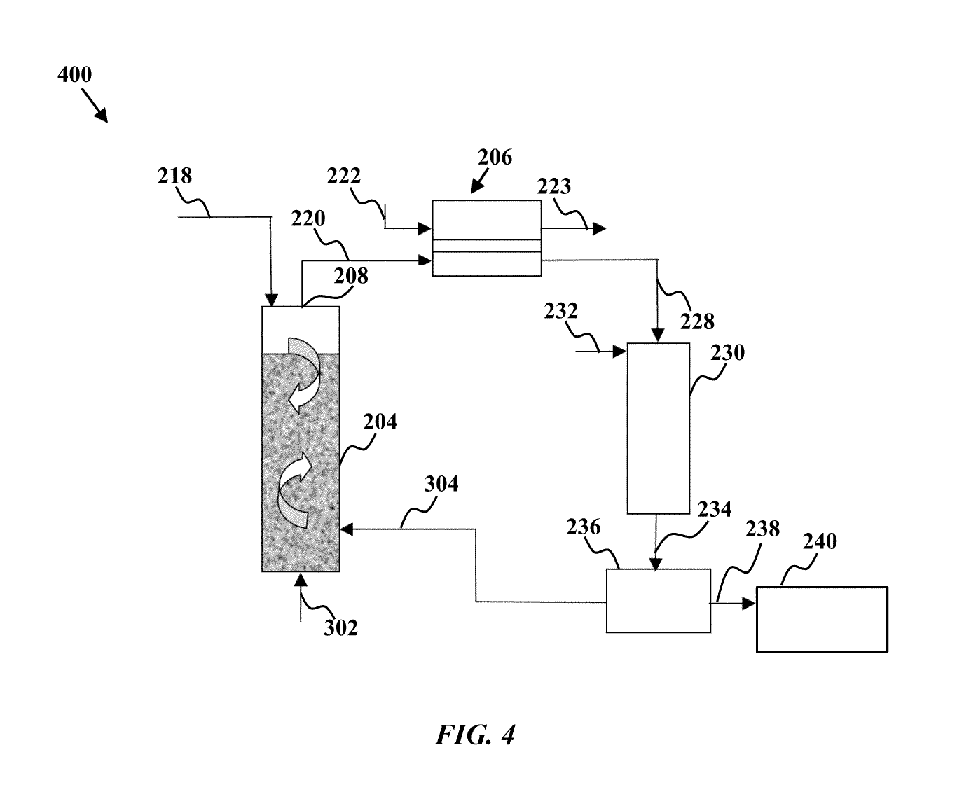

FIG. 4 shows a single SOFC embodiment 400 of the current invention, where only the external SOFC 206 is integrated to the gasifier 204. Here, the internal SOFC (not shown) can be omitted from the gasifier completely. In this configuration, the dry gasification products of CO and CO₂ can be fed to the external SOFC 206 to generate electricity.

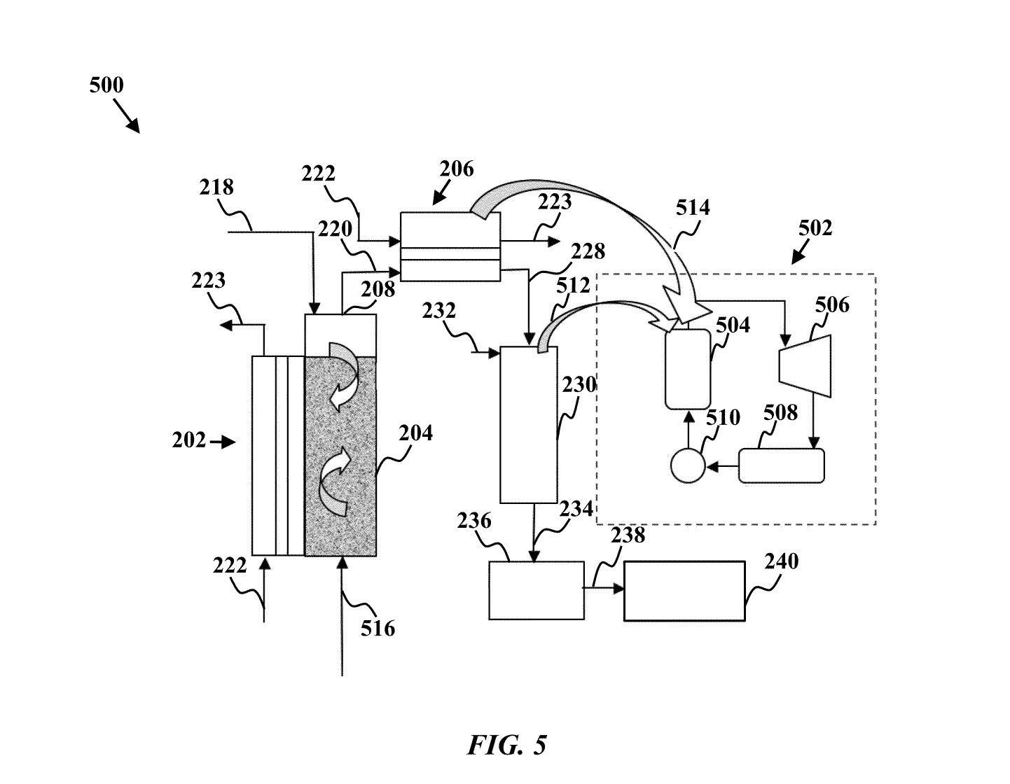

In the embodiments of FIGS. 2, 3 and 4, water 516 (shown in FIG. 5) in substoichiometric amounts may be added to the gasifier 204 in order to enhance fuel cell kinetics and electric power generation capacity. Hydrogen formed in the gasifier 204 due to reactions between coal and water is oxidized in the internal SOFC 202 (see FIGS. 2 and 3) back to water again, increasing the power generation rate. Water in the stream of the gasifier exit 208 can be condensed before the stream enters the external SOFC bundle 206. Water in the stream directed to the sequestration site 226 must also be condensed from the stream. Water from all these sources can be recycled back to the gasifier 204.

FIG. 5 shows an IDG-FC and Rankin power cycle 500, where the external SOFC 206 integrated with a Rankine power cycle 502 for increased power output and efficiency. Heat engines and fuel cells must reject heat or hot products in accordance with the laws of thermodynamics. The Rankine bottoming cycle 502 includes a boiler 504 that provides steam to a steam turbine 506, where the output steam is input to a condenser 508 and the condensed water is input to a pump 510 to pump the water back into the boiler 504. The external SOFC 206 rejects heat at high temperature (nominally 900° C. for the DCFC), which can be utilized in a separate bottoming cycle to extract further work and increase efficiency. This is supplemented by the carbon monoxide burner 230, which also liberates and rejects heat at high temperature. Additional heat is available for the bottoming cycle 502 as DCFC products are cooled for gas cleanup. A Rankine cycle, of any complexity, is a natural choice of bottoming cycle for the DCFC due to the maximum steam turbine inlet temperature of about 600-650° C. This matches favorably with the nominally 900 C heat rejection from the fuel cell. The addition of the steam bottoming cycle adds nominally 10% to the efficiency of the DCFC plant. In one embodiment of the invention, the external SOFC 206 uses the air exhaust 223 from the cathode 212, where heat energy from the exhaust air is reclaimed 514. The reclamation includes providing the cathode heat energy to the boiler 504 of a Rankine engine 502. In another embodiment, the external SOFC 206 further includes a product stream output 228 from the anode 210, where heat energy from the product stream output 228 is reclaimed 512. Here, the reclamation includes providing the anode heat energy to a boiler 504 of a Rankine engine 502.

The current invention provides many important advantages for improved efficiency in power plants. For example, there is only limited use the CO₂-rich stream that is separated from the flue gas of industrial coal-fired boilers and furnaces, these include the current industrial uses of CO₂ as in enhanced oil recovery, and extraction or separation processes using supercritical CO₂ as a powerful solvent. The current use is to divert this CO₂ stream directly to the sequestration site. The present invention provides a technological and business opportunity to further utilize this otherwise waste CO₂ stream. The gasification scheme with fuel cell integration disclosed here employs this stream to generate electricity from coal with increased efficiency.

The efficiency of a present-day pulverized coal-fired power plant is about 34%, consequently about 10,600 kJ of coal energy input is needed to produce a kWh of electricity. If the coal used were a typical high-volatile bituminous coal (C/H/O/N/S˜70.0/4.6/6.8/1.3/1.3 percent by mass, with a higher heating value of ˜30 MJ/kg), about 0.90 kg of CO₂ would be produced in the process. The newer supercritical pulverized coal-fired power plants have efficiencies near 38%, thereby requiring about 9500 kJ of coal energy input to generate a kWh of electricity, producing about 0.81 kg of CO₂. Based on these numbers, a 100 MWe power plant that uses a typical high-volatile bituminous coal as an energy source will produce as much as 25 kg/s of CO₂. With 25 kg/s of CO₂ and 32.6 kg/s of coal supplied to the gasifier and 19.6 kg/s of O₂ supplied through the SOFC, the potential exist to produce 405 MWe of additional power, assuming a cell operating voltage of 0.6 V. This provides over 42% conversion efficiency.

Having a fuel cell 202 located inside the gasifier 204 where the reactive gases are generated has the advantage of maintaining a uniform, high-concentration of CO along the surface of the anode 210 of the fuel cell 202. This enhances the transport of CO through the porous anode 210, thereby increasing the oxygen gradient across the electrolyte 214 of the fuel cell 202, increasing the fuel cell's power density. An advantage of using an internal SOFC 202 is that electric power can be generated as oxygen is supplied to oxidize the fuel.

Advantages of locating the facility at an IGCC coal-fired power plant include: (i) utilization of waste heat from the IGCC plant and (ii) access to and utilization of O₂ from the IGCC's existing air separation facility. Furthermore, the IDG-FC process will benefit from the existing infrastructure for coal delivery, storage, and grinding and for the existing power distribution grid.

According to further embodiments, the current invention overcomes a major technical hurdle that stands in the way of utilizing coal and other solid fuels in high temperature fuel cells, specifically anode deactivation due to poisoning primarily by sulfur, sulfurous compounds, as well as other contaminants. One embodiment includes an integrated process scheme and method that consolidates the otherwise separate processes of coal gasification, effective removal of sulfur, sulfurous compounds and also other contaminants from coal syngas, and electrochemical oxidation of the syngas in a fuel cell all in a single-chamber for highly efficient generation of electrical power from coal and other solid fuels, while producing significantly reduced amounts of greenhouse gas CO₂. Since sulfur, sulfurous compounds, and other contaminants are removed in situ, the clean syngas can readily be oxidized on the anode surface without significant loss in cell performance. Furthermore, this integrated process scheme enables effective thermal management, eliminates unnecessary heat losses, and maximizes overall conversion efficiency of coal and other solid fuels in high temperature fuel cells. Since no nitrogen enters the process stream, the product of the fuel cell is capture-ready CO₂ that can be sequestered readily.

In one embodiment, the invention provides in situ sulfur and sulfurous compound removal from coal gasification products inside a Fluidized Bed Integrated Dry Gasification Fuel Cell (FB-IDG-FC) environment, where a portion of the anode product gases are recycled back into the solid carbon fuel bed, although it is generally applicable to other types of carbon fuel cells including solid oxide electrolyte, molten carbonate electrolyte, molten hydroxide electrolyte, molten metal anode, and their hybrids and combinations. The FB-IDG-FC enables electrochemical conversion of coal and other solid fuels into electrical energy. Since gasification in FB-IDG-FC is accomplished not by steam but by CO₂, this approach does not require or consume water, and produces a capture-ready CO₂ flue stream.

Until now, coal contaminants, particularly sulfur and sulfurous compounds, stood in the practical development path of carbon fuel cells including FB-IDG-FC, as well as integrated gasification fuel cell (IGFC) technologies in general.

One embodiment of the current invention provides an integrated single-chamber process scheme containing regenerative sulfur sorbents materials for in situ removal of sulfur, sulfurous compounds and other contaminants from coal syngas, and electrochemical oxidation of syngas at the anode surface of FB-IDG-FC, or other types of fuel cells.

Although coal can clearly meet most of the growth in the global electricity demand for many decades to come, it can only do so if highly efficient and environmentally friendly conversion technologies are developed to mitigate the risk of climate change and environmental impact. In this regard, coal conversion in fuel cells offers high efficiencies that are otherwise not possible to achieve by chemical conversion processes.

The efficiency for electrochemical conversion, η, is defined as η=ΔGₒ/ΔHₒ, where ΔGₒ is standard Gibbs free energy and ΔHₒ is standard enthalpy. In the case of carbon oxidation, the entropy change within practical temperatures remains extremely small (e.g., 0.58 J/K·mol at 1200K). Consequently, both the cell equilibrium potential of about 1V and the theoretical conversion efficiency of 100% are practically independent of operating temperature. High conversion efficiencies naturally translate into proportionately less emissions of capture-ready CO₂. It helps reduce the environmental impact and carbon footprint of coal conversion.

Moreover, the FB-IDG-FC arrangement for coal conversion as part of the current invention operates at elevated temperatures (800-900° C.). Such high temperatures offer fuel flexibility that greatly expands the range of solid fuels, and also produce high quality waste heat that can be utilized in a bottoming cycle to boost the overall system level conversion efficiency.

The difficulty of supplying the solid fuel particles to the TPB of a SOFC can be circumvented by steam gasification to generate H₂ and CO, or syngas, via the reaction

C+H₂O=H₂+CO (7)

If desired, H₂ and CO can readily diffuse into the anode structure and undergo electrochemical oxidization at the TPB. Steam gasification reaction (7) of carbon is an endothermic process with an enthalpy of 136 kJ/mol at 1100K. So usually, oxygen (or, air) is injected into the gasifier along with steam to sacrificially burn part of the carbon in order to supply the heat necessary to drive the gasification reaction. As in SECA and FutureGen projects, the syngas is shifted catalytically with further addition of steam to produce more H₂ for the SOFC.

CO+H₂O=H₂+CO₂ (8)

The net reaction after steps (7) and (8) is given by,

C+2H₂O=2H₂+CO₂ (9)

This is an endothermic reaction with an overall enthalpy change of +102 kJ/mol at 1100K.

In the case of dry gasification using the Boudouard reaction,

C+CO₂=2CO (10)

The enthalpy change in (10) is slightly more endothermic than in (9), with a value of +169 kJ/mol at 1100K.

The two fuels, regardless of the type of gasification, when electrochemically oxidized at the anode TPB of the SOFC will undergo the corresponding reactions,

2H₂+2O₋₂=2H₂O+4e′ (11)

2CO+2O₋₂=2CO₂+4e′ (12)

Energetics of CO and H₂ oxidation, calculated from thermochemical data indicate that the enthalpy change for the CO oxidation reaction is significantly more exothermic than for the oxidation of H₂ (i.e., −562 kJ·mol₋₁ of O₂ versus −495 kJ·mol₋₁ of O₂, respectively). So there is no significant energetic difference between steam and dry gasification. Moreover, reactions (11) and (12) exhibit similar values for the standard Gibbs energy (i.e., −185 kJ·mol₋₁ of O₂ versus −186 kJ·mol₋₁ of O₂) at 850° C., indicating almost identical work potentials offered by the oxidation of either fuel. Energetically, steam gasification and dry gasification are quite comparable, and steam gasification provides no significant advantage over dry gasification. Consequentially, the current invention is equally applicable and beneficial to either gasification scheme.

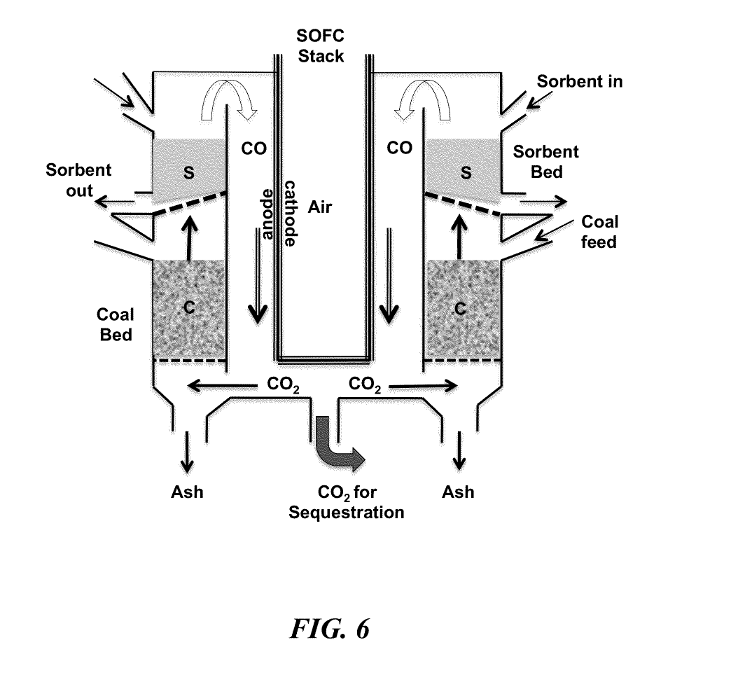

The current invention provides a FB-IDG-FC that is capable of the removal of sulfur and sulfurous compounds specifically, and other contaminants from gasification products of solid fuels including coal, in a single chamber that also houses the gasified coal bed and the fuel cell stack. This single chamber process provides effective thermal management and avoids heat losses, eliminates separate process steps otherwise needed for cooling down and heating up of gas streams for gas cleanup followed up by water-gas shift process, and maximizes system conversion efficiency. It is important to consider that the highly exothermic oxidation of CO to CO₂ occurring on the anode surfaces of the fuel cell stack is where heat is primarily generated in the chamber. The general flow of the process stream involves the gasification of the solid fuel either by steam or by CO₂ to form syngas, sulfur and sulfurous compound removal in the solid sorbent bed from the syngas, and oxidation of the clean syngas at the fuel cell stack to generate power. Part or all of the oxidation products exiting the fuel cell stack section can be recirculated through the solid fuel bed for further gasification. The physical proximity of the solid fuel bed and the sulfur sorbent bed to the heat source minimizes heat losses, renders effective thermal management easy, and maximizes efficiency. It is with these considerations in mind that the schematic illustrations of the process design are shown in FIGS. 6-13. Although for simplicity, only the case for solid oxide fuel cell (SOFC) geometry with dry gasification by CO₂ is shown in the figures, it is understood that all other fuel cell types and geometries as well as steam gasification fall under the premise of this invention and are equally applicable.

In FIGS. 6-13, S denotes the solid sorbent bed to remove sulfur and sulfurous compounds from syngas, C denotes the solid fuel bed, and a faction of the CO₂ produced in the fuel cell stack can be captured and sequestered. Again for simplicity and brevity, only the major details are provided for descriptive purposes. Other designs capturing the same concept and same intent and goal are of course applicable to this invention.

FIG. 6 shows a FB-IDG-FC process design including a one-end closed tubular SOFC geometry at the center of the chamber with radially placed solid fuel and sorbent beds, and one example of gas and material flow patterns in the chamber, according to one embodiment of the invention.

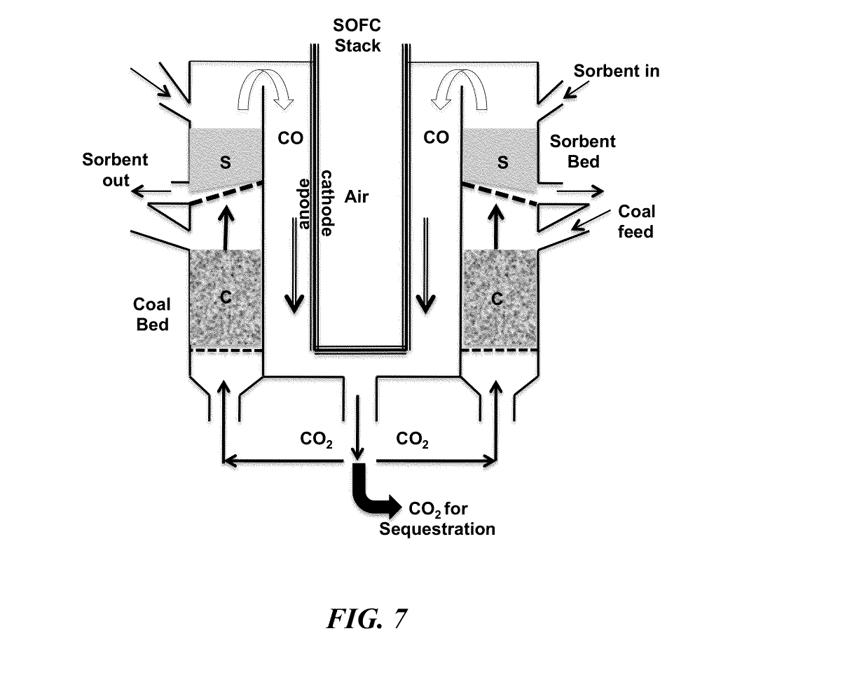

FIG. 7 shows a FB-IDG-FC process design including a one-end closed tubular SOFC geometry at the center of the chamber with radially placed solid fuel and sorbent beds, and a second example of gas and material flow patterns in the chamber, according to one embodiment of the invention.

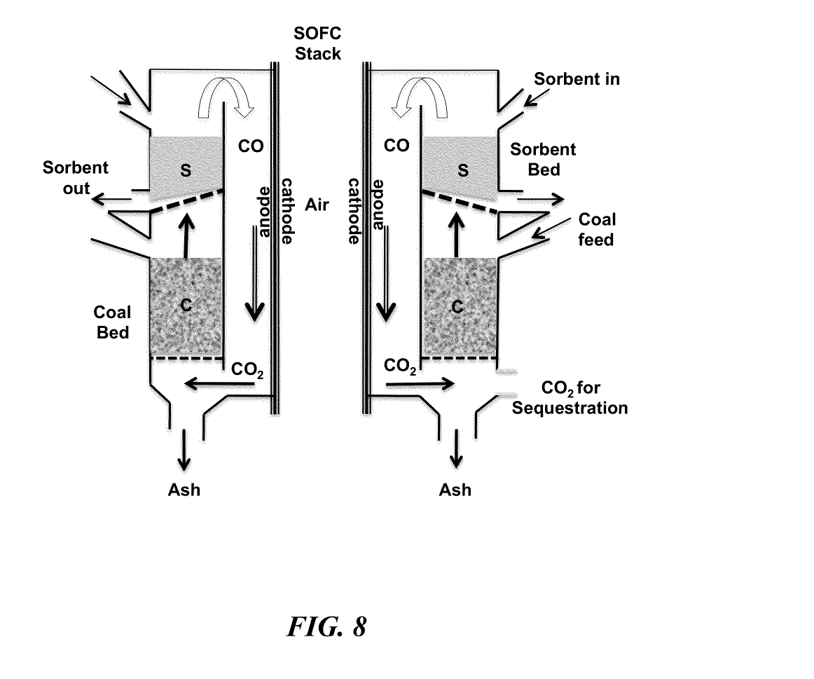

FIG. 8 shows a FB-IDG-FC process design including a open-ended tubular SOFC geometry at the center of the chamber with radially placed solid fuel and sorbent beds, and an example of gas and material flow patterns in the chamber, according to one embodiment of the invention.

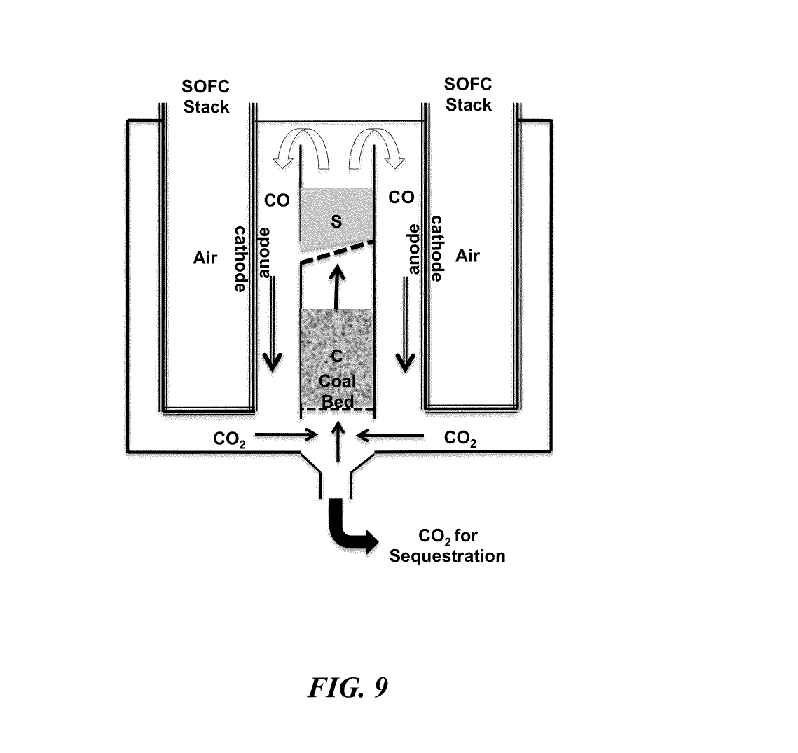

FIG. 9 shows a FB-IDG-FC process design including a one-end closed tubular SOFC geometry radially circling the solid fuel and sorbent beds located at the center of the chamber, and one example of gas and material flow patterns in the chamber, according to one embodiment of the invention.

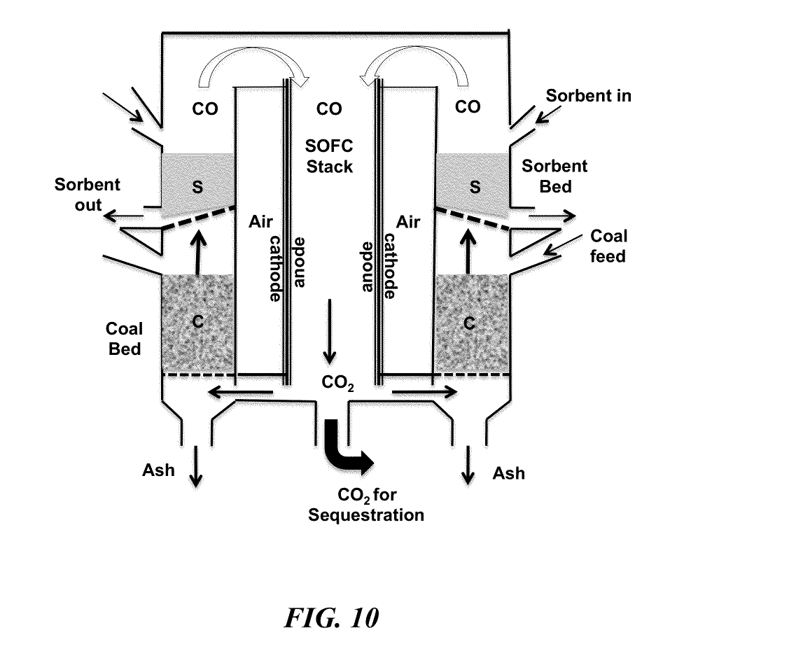

FIG. 10 shows a FB-IDG-FC process design including an open-ended tubular SOFC geometry at the center of the chamber with radially placed solid fuel and sorbent beds, and one example of gas and material flow patterns in the chamber, according to one embodiment of the invention.

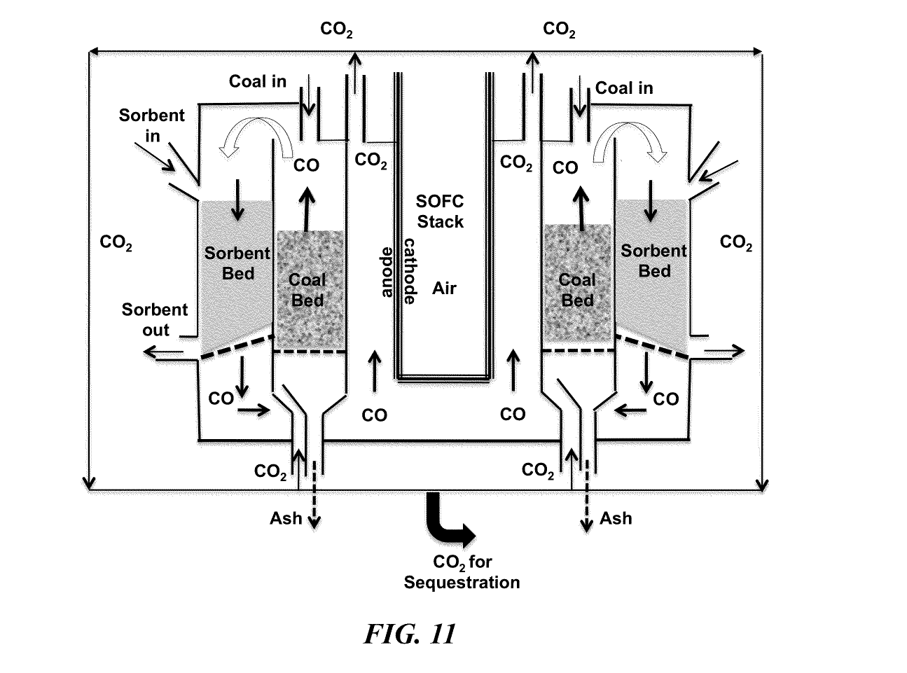

FIG. 11 shows a FB-IDG-FC process design including an open-ended tubular SOFC geometry at the center of the chamber with radially placed solid fuel bed and the outermost sorbent bed, and one example of gas and material flow patterns in the chamber.

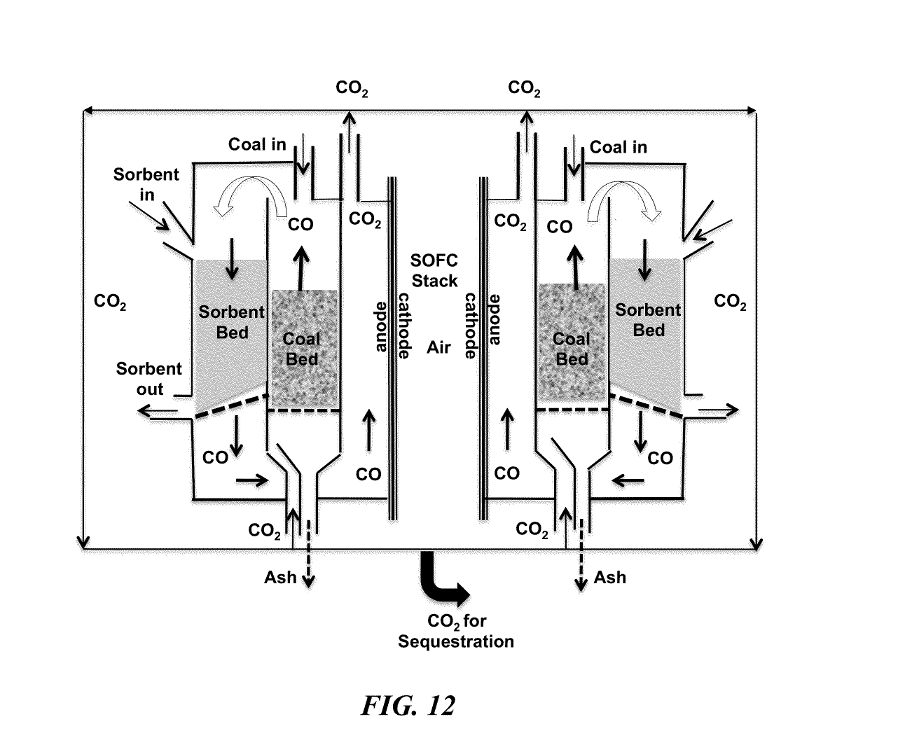

FIG. 12 shows a FB-IDG-FC process design including an open-ended tubular SOFC geometry at the center of the chamber with radially placed solid fuel bed and the outermost sorbent bed, and one example of gas and material flow patterns in the chamber, according to one embodiment of the invention.

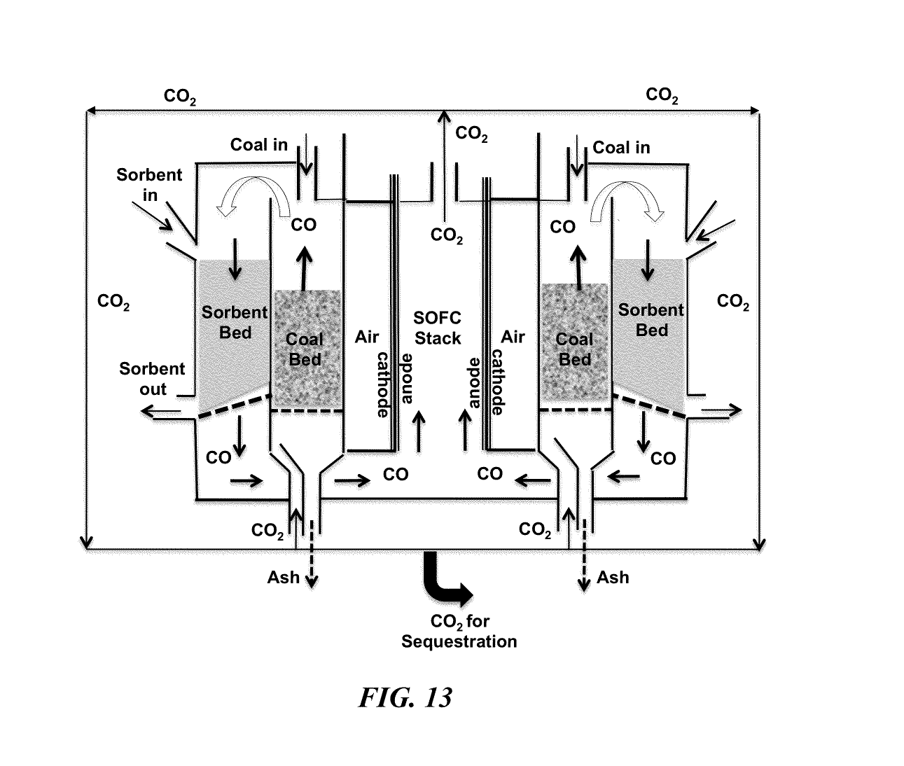

FIG. 13 shows another FB-IDG-FC process design including an open-ended tubular SOFC geometry at the center of the chamber with radially placed solid fuel bed and the outermost sorbent bed, and one example of gas and material flow patterns in the chamber, according to one embodiment of the invention.

Turning now to the FB-IDG-FC of the current invention. Since the general approach of one embodiment of the current invention that achieves sulfur and sulfurous compound removal and coal conversion in a single process chamber is shown in the figures in the context of the FB-IDG-FC as an example, the following briefly describes the fundamentals of FB-IDG-FC.

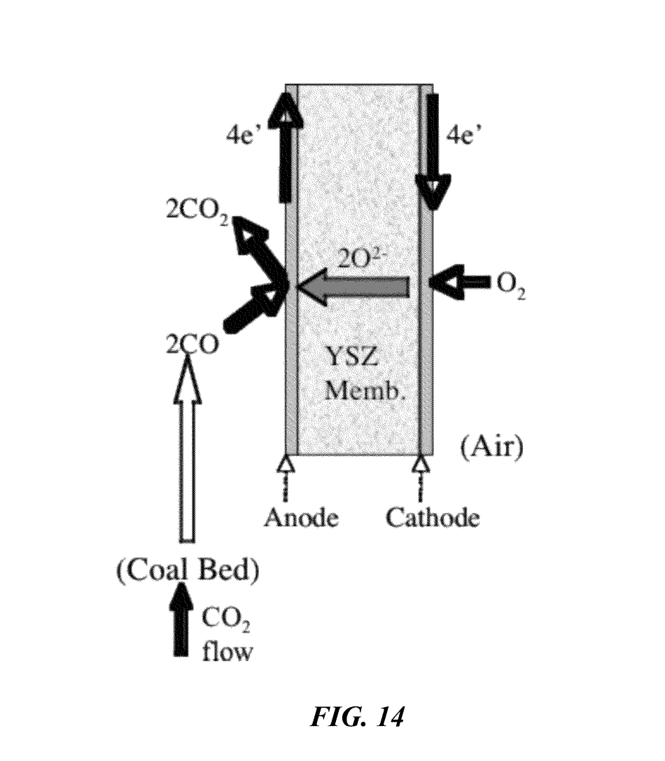

The FB-IDG-FC technology basically involves a solid oxide fuel cell arrangement integrated thermally to a Boudouard gasifier containing a bed of coal or other solid carbonaceous fuels. The fuel cell element includes a solid oxide electrolyte, a cathode where oxygen (usually from air) is reduced, and an anode, where the fuel is oxidized, whereby electrons released during the oxidation reaction travels through the external circuit (or grid) to the cathode to complete the loop and participate in reduction reaction for oxygen. The solid oxide electrolyte selectively transports oxide ions through its crystal lattice via oxygen vacancies generated upon extrinsic doping with aliovalent cation(s). The oxygen in air at the cathode side is reduced to oxide ions that migrate to the anode side due to the electrochemical potential gradient. FIG. 14 shows the net reactions and processes involved in FB-DCFC.

Part of the CO oxidation product CO₂ is recirculated through the coal bed to facilitate gasification via the Boudouard reaction,

C+CO₂=2CO (1)

The remaining part of the CO₂ is capture-ready and can be collected for sequestration. The CO formed during the Boudouard reaction diffuses to the TPB at the anode interface and is electrochemically oxidized to CO₂. The reaction chamber housing the Boudouard gasifier and the fuel cell stack operate in the temperature regime of 800-900° C.

This FB-IDG-FC scheme and other direct carbon fuel cells become viable for practical applications only if the gasification fuel products do not contain contaminants detrimental to the optimum and stable operation of the cell anode material, which is clearly not the case for most solid carbonaceous fuels including coal. So this invention enables the viability of FB-IDG-FC technology as well as other fuel cell approaches for electrochemical conversion of untreated coal and other solid fuels.

Turning now to solid sorbents for sulfur and sulfurous compound removal from dry-gasification gases, calcium-based sorbents such as limestone (nominally calcite, CaCO₃) and dolomite (CaMg(CO₃)₂) are effective in removing SO₂ from combustion gases at temperatures as high as 1000° C. Sulfur is captured as both CaSO₄ and MgSO₄. More than 95% sulfur capture has been reported. Fluidized bed combustion of coal with limestone or dolomite injection to capture SO₂ is a well-established, commercially available technology in the oxidizing environment in combustors. However, the reducing atmosphere (i.e., very low oxygen activity) at the anode compartment of FB-IDG-FC and IDG-FC favors the formation of H₂S, COS and CS, which poses challenges for removal. The present invention addresses removal of these sulfurous compounds from the syngas.

The sulfur uptake rate by the sorbents is rapid initially but gradually decreases as pore plugging occurs, a consequence of CaSO₄ and MgSO₄ formation on the periphery of particles hindering the transport of the SO₂ to interior surfaces. Sulfur dioxide uptake changes from a fast, chemical-controlled process to a slow, diffusion controlled process as sulfur uptake increases.

Owing to plugging, limestone and dolomite particles are considerably under-utilized in fluidized bed applications, requiring two to four times the stoichiometric requirements for sufficient sulfur removal. Since only a small mass fraction near the external surfaces is utilized, one embodiment of the invention implements submicron size sorbent particles dispersed on suitable porous supports.

Certain additives (e.g., NaCl, CaCl₂, Na₂CO₃, and Fe₂O₃) increase the sulfur capture capacity of limestones. These additives increase the mean pore size of the calcined particles, permitting deeper penetration of sulfur into the particles, thereby enhancing limestone utilization. This increase is attributed to an increase in the ionic mobility in the CaO crystal lattice due to formation of vacancies in the crystal when Ca is partly replaced by Na. The increase in the mean pore size facilitates reaction with limestone grains throughout the whole particle without rapid plugging of pores, avoiding premature change from a fast chemical reaction controlled process to a slow, solid-state diffusion controlled process.

Limestones and dolomites are also effective sorbents in capturing H₂S and COS from coal gasification gases. Sulfur is captured as both CaS and MgS. As with CaSO₄ formation in oxidizing environments, the CaS formed can plug particle pores, causing the sulfur uptake rate to gradually decrease in time. Ninety-five percent removal of sulfur from the syngas produced from the gasification of Pittsburgh #8 would yield a gas-phase sulfur level that exceeds 5 ppmv. Sorbents more effective than limestones and dolomites are needed for sustained FB-IDG-FC operation.

Zinc-based materials are also known to be effective sulfur sorbents due to reaction with H₂S and COS to form ZnS. However, ZnS is unstable above 600° C., so is not suitable for the high temperature requirements of the proposed FB-IDG-FC system. Therefore, new sorbent materials that bind sulfur strongly at high temperatures as high as 900° C. in reducing environments are needed.

Preliminary calculations using thermochemical data are performed for this purpose to identify potential sorbents that bind sulfur strongly at high temperatures.

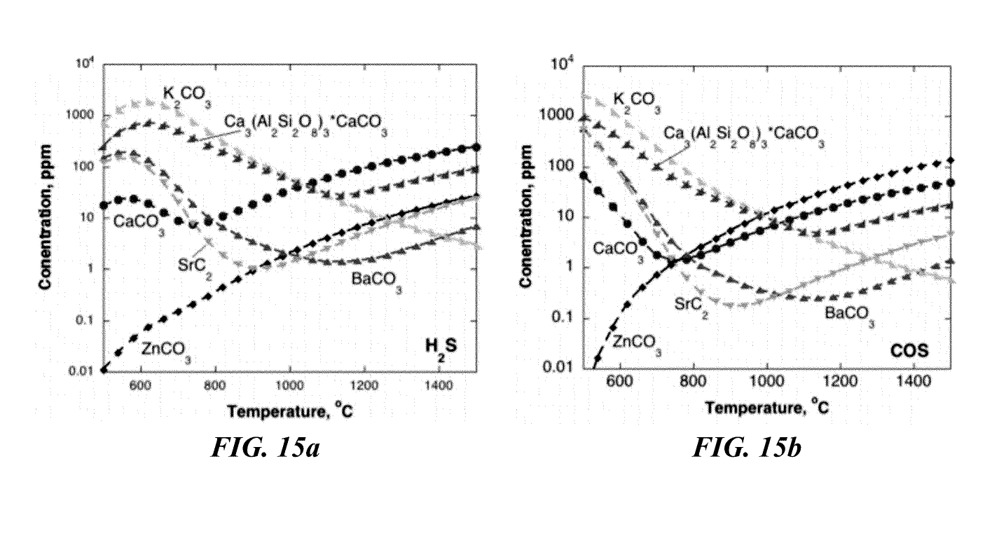

Shown in FIGS. 15a-15b are calculated equilibrium sulfur mole fractions when a syngas produced from the dry gasification of Pittsburgh #8 at 900° C. is exposed to six different sorbents. In each case, two moles of the sorbent are added for each mole of sulfur in the syngas. As noted from the figures, barium carbonate (BaCO₃) and strontium carbide (SrC₂) have the potential to reduce both the H₂S and COS levels below 5 ppmv. Strontium carbonate (SrCO₃), not shown, have the potential to reduce these as well. Zinc carbonate (ZnCO₃) would reduce the COS and H₂S concentrations below the 5 ppmv level at temperatures less than 850° C. The solid sulfur compound formed is the sulfide of the metal (CaS, BaS, SrS, and ZnS), all of which are stable at temperatures near 900° C. However, problematic for zinc-based sorbents is the fact that zinc is volatile at temperatures above 600° C.; barium and strontium are not. Only at temperatures greater than 1100° C. are H₂S and COS levels reduced below 5 ppmv with potassium based (K₂CO₃) sorbents.

Thermodynamic calculations indicate that the higher the molar active metal-to-sulfur ratio, the lower the equilibrium levels of H₂S and COS. This is the primary reason for the effectiveness of meionite (Ca₃(Al₂Si₂O₈)₃CaCO₃) and vesuvianite (Ca₁₉Mg₂Al₁₁Si₁₈O₆₉(OH)₉), naturally occurring minerals. Consequently, with higher sorbent levels, (more than 2 moles of sorbent for each mole of gas-phase sulfur to be removed) the concentrations of H₂S and COS could be reduced below the levels indicated in FIGS. 15a-15b. For example with potassium-based (K₂CO₃) sorbents, only at temperatures greater than 1100° C. are equilibrium levels of K₂S sufficient to maintain H₂S and COS levels below 5 ppm. Additional moles of K₂CO₃ could be used (more than two moles of the sorbent per mole of sulfur in the syngas) to lower the H₂S and COS levels to less than 5 ppm at temperatures near 900° C. Similar results were obtained with CoCO₃ (calculated results for CoCO₃ are not shown in the figures). Two moles of CoCO₃ per mole of sulfur lowered the gas-phase sulfur level to the 10-20 ppm range; addition moles would lower the H₂S and COS levels to below 5 ppm. With larger quantities of sorbent (more than 5 moles of sorbent per mole of sulfur to be removed), the carbonates and carbides of Fe, Mg, Mn also capture sufficient amounts of H₂S and COS to render gas phase sulfur levels to less than 5 ppmv.

Carbonates and carbides of the alkaline earth metals are ideal for sulfur sorbents for FB-DCFC applications. Carbonates and carbides of the transition metals are suitable at relatively large metal/S ratios. From thermochemical analysis by the inventors, an exemplary list of solid sorbent materials and sorbent additives is provided, where the solid sorbent can include one or any combination of limestone, calcite, CaCO₃, magnesium carbonate, magnesium carbide, barium carbonate, barium carbide, strontium carbide, strontium carbonate, zinc carbonate, zinc carbide, dolomite (CaMg(CO₃)₂), meionite (Ca₃(Al₂Si₂O₈)₃CaCO₃) and vesuvianite, (Ca₁₉Mg₂Al₁₁Si₁₈O₆₉(OH)₉), K₂CO₃, CoCO₃, carbonates and carbides of Fe, Mg, Mn, carbonates and carbides of alkaline earth metals, and carbonates and carbides of transition metals, and optionally with additives such as NaCl, CaCl₂, Na₂CO₃, and Fe₂O₃, BaCO₃, SrC₂SrCO₃, ZnCO₃, and K₂CO₃.

The sorbents can be regenerated for use at the commercial scale. With gasification gases, the sulfur compounds are absorbed primarily as sulfides (e.g., CaS, SrS and BaS). The spent sorbents can be regenerated by exposing them to CO₂ at low temperatures, producing elemental sulfur and COS. The sulfur in the COS can be recovered by first hydrolyzing the COS to H₂S, and then converting the H₂S to elemental sulfur via the Claus process. Equilibrium calculations indicate that at temperatures up to about 500° C., over 90% of the sorbent in the BaS and SrS forms will be converted back to the carbonates.

In another embodiment of the invention, the solid sorbent is further capable of removing phosphorus, mercury, arsenic, cadmium, antimony, selenium, lead, chromium, chlorine, fluorine, alkaline earth metals or rare earth metals.

This invention also provides dispersing the solid sorbent in fine particulate form on to porous substrates, where sorbent utilization increases with decreasing grain size. Rather than using course and large size sorbents, it is preferable to employ fine size high surface area sorbents for efficient sulfur take up. However, in this particle size regime from submicron to several microns, it is difficult to handle and manage the solid sorbent in fuel cells, and particularly in the gas flow environment of FB-IDG-FC. In the fuel cell environment, it is important to minimize sorbent entrainment in the gas flow and to avoid agglomeration and sintering of the sorbent particles. These lead to loss of surface area and loss of sorbent mass, which collectively decrease in the sulfur take up capacity over time.

These adverse effects can be minimized by dispersing the sorbent particles on a porous support material such as alumina or zirconia. These materials are commonly employed as catalyst supports in industrial scale. They are also chemically inert and stable in and compatible with the reducing conditions at the anode environment of fuel cells.

In a further embodiment, the invention provides dispersing the sorbents on to the porous supports using two different approaches. The first involves an infiltration method employing soluble salts of the sorbent material. Salts of the cations that make up the sulfur sorbent are dissolved in either water or another suitable solvent. The total amount of dissolved cations in solution may be up to 2M. The internal pores and external surfaces of the support particles are infiltrated by the salt solution, followed by drying for solvent removal and heating in the appropriate environment to form the fine dispersed particles of the desired sorbent material on the external and internal surfaces of the porous support material.

The second approach employs saturated salt solutions or melts of the sorbent material as well as sol-gel synthesis routes to obtain colloidal solution of the sorbent particles in the submicron size. The porous support material is coated by the sorbent by dipping into the colloidal solution, saturated solution or melt, followed by solvent removal, and heating in order to form the sorbent layer or deposit on the external and internal surfaces of the porous support material.

Some advantages of the current invention include a single chamber integrated process scheme for sulfur removal, gasification and fuel conversion; in situ removal of sulfur and other contaminants from syngas; regenerable solid sorbents for sulfur removal; effective thermal management that minimize heat losses and maximize efficiency; high conversion efficiencies nearly doubly that of conventional coal fired power generation; nearly half the amount of CO₂ emissions; nearly half the amount of pollutant emissions; no requirement for water if dry gasification is opted; wide spectrum of fuel flexibility ranging from coals, to biomass, to agricultural and forestry waste, to plastic waste, to municipal waste, and other types of solid fuels; modular and scalable; suitable for centralized base load or distributed power generation; and since only the nitrogen in the coal enters the process stream, NOₓ emissions are low.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. An integrated gas fuel cell comprising:
a. at least one carbon monoxide gas fueled solid oxide fuel cell, wherein said carbon monoxide gas fueled fuel cell comprises a carbon monoxide oxidizing anode, wherein an anodic oxidation of said carbon monoxide is provided by said carbon monoxide oxidizing anode in said presence of carbon monoxide, a cathode, an oxide ion transporting electrolyte membrane, and a product stream output from said carbon monoxide oxidizing anode, whereby said membrane is disposed between said carbon monoxide oxidizing anode and said cathode;
b. a gasifier, wherein said carbon monoxide gas fueled solid oxide fuel cell is integrated to said gasifier, wherein said gasifier converts carbon monoxide gas from carbon dioxide gas, wherein a bed of carbonaceous fuel is provided to said gasifier to facilitate said gas conversion, wherein said carbon monoxide gas is directly provided as fuel to said carbon monoxide oxidizing anode inside said gasifier, wherein said at least one carbon monoxide gas fuel cell is physically and thermally integrated with said gasifier within a single chamber, wherein a Boudouard reaction product carbon dioxide is formed directly inside said at least one carbon monoxide gas fueled solid oxide fuel cell, wherein when an electrochemical oxidation reaction of said carbon monoxide occurs at a surface of said carbon monoxide oxidizing anode by oxide ions supplied through said oxide ion transporting electrolyte membrane from said cathode for said electrochemical oxidation reaction of said carbon monoxide gas at said surface of said carbon monoxide oxidizing anode to generate electric power, wherein said electrochemical oxidation reaction comprises CO(g)+O_{O}^{X}→CO₂(g)+V_{O}^{\ddot{}}+2e⁻ yielding electrons for said electrical power generation; and
c. a solid sorbent bed inside said gasifier, wherein said solid sorbent bed is disposed for in situ capture and removal of sulfur and sulfurous compounds from said carbon monoxide gas converted from carbon dioxide gas in said gasifier, wherein said fuel cell, said gasifier, and said solid sorbent bed are within the same thermal and physical enclosure.

2. The integrated gas fuel cell of claim 1, wherein said in situ capture and removal by said solid sorbent is further capable of removal of contaminants selected from the group consisting of phosphorus, mercury, arsenic, cadmium, antimony, selenium, lead, chromium, chlorine, fluorine, silicon and silicon compounds, alkaline earth metals, and, rare earth metals.

3. The integrated gas fuel cell of claim 1, wherein said solid sorbent comprises materials selected from the group consisting of limestone, calcite, caco₃, magnesium carbonate, magnesium carbide, barium carbonate, barium carbide, strontium carbide, strontium carbonate, zinc carbonate, zinc carbide, dolomite (CaMg(CO₃)₂), meionite (Ca₃(Al₂Si₂O₈)₃CaCO₃) and vesuvianite, (Ca₁₉Mg₂Al₁₁Si₁₈O₆₉(OH)₉), K₂CO₃, CoCO₃, carbonates and carbides of Fe, Mg, Mn, carbonates and carbides of alkaline earth metals, carbonates and carbides of transition metals, NaCl, CaCl₂, Na₂Co₃, and Fe₂O₃, BaCO₃, SrC₂ SrCO₃, ZnCO₃, K₂CO₃, MgCO₃, MgC₂, BaC₂, ZnC₂).
